(19) United States
(12) Patent Application Publication
(10) Pub. No.: US 2011/0146476 A1
(43) Pub. Date: Jun. 23, 2011

(54) SYSTEMS AND METHODS OF INSTRUCTION INCLUDING VIEWING LESSONS TAKEN WITH HANDS-ON TRAINING

(76) Inventor: Edward Zimmerman, Tega Cay, SC (US)

(21) Appl. No.: 12/946,483

(22) Filed: Nov. 15, 2010

Related U.S. Application Data
(63) Continuation-in-part of application No. 12/945,859, filed on Nov. 13, 2010.
(60) Provisional application No. 61/287,743, filed on Dec. 18, 2009.
(60) Provisional application No. 61/292,743, filed on Jan. 6, 2010.
(60) Provisional application No. 61/287,743, filed on Dec. 18, 2009.
(60) Provisional application No. 61/292,743, filed on Jan. 6, 2010.

(51) Int. Cl. G09B 15/00

(52) U.S. Cl. 84/470 R

(57) ABSTRACT

A method of instruction by a teacher to a student with hands-on training includes presenting instruction to the student by the teacher; recording portions of the instruction presented; and storing the recording such that the recording is accessible via a wide area network by the student using an electronic device for viewing of the recorded portions of the lesson after the lesson has been taken.

### CROSS-REFERENCE TO RELATED APPLICATION

The present application is a continuation-in-part patent application of, and claims priority under 35 U.S.C. §120 to, U.S. patent application Ser. No. 12/945,859, filed Nov. 13, 2010, incorporated herein by reference, which '859 patent application is a U.S. nonprovisional patent application of, and claims priority under 35 U.S.C. §119(e) to, U.S. provisional patent application Ser. No. 61/287,743, filed Dec. 18, 2009, and U.S. provisional patent application Ser. No. 61/292,743, filed Jan. 6, 2010, both of which are hereby incorporated by reference herein. The present application also is a U.S. nonprovisional patent application of, and claims priority under 35 U.S.C. §119(e) to, U.S. provisional patent application Ser. No. 61/287,743, filed Dec. 18, 2009, and U.S. provisional patent application Ser. No. 61/292,743, filed Jan. 6, 2010, both of which are hereby incorporated by reference herein. The disclosure of 61/292,743 is contained in the Appendix to the Specification and is incorporated by reference herein.

### COPYRIGHT STATEMENT

All of the material in this patent document, including source code, is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to systems and methods for instruction and, in preferred systems and methods, for musical instruction.

In order to gain knowledge and understanding in the field of music, it is often necessary or desirable to seek lessons or instruction from a professional music teacher. In a typical lesson, the student and teacher will meet at a predetermined venue for a set length of time. The lesson usually comprises communication by the teacher to the student of a combination of music theory and technique, as well as the teacher walking through exercises with the student that will help the student reach their musical goals. The intention is that the student will retain the information presented and incorporate it into the student's musical repertoire through study and practice. However, it will be appreciated that music lessons can contain an overwhelming amount of information, much of which is highly technical in nature. Examples of such information include complex rhythms, melodies, and harmonies, fingerings, chord voicings, breathing techniques, posture and body position, aperture settings, dynamics, and music notation. Even with extensive note-taking, a student is likely to miss and later forget some of the information given during a lesson. Moreover, even if detailed notes are taken, much of the information—due it its aural nature—is not adequately conveyed on paper.

In view of these shortcomings, it is believed that a need exists for improvement in systems and methods for instruction and, in preferred systems and methods, for musical instruction. It is believed that this need is addressed by one or more aspects of preferred embodiments of the present invention, which is intended to target lesson retention by students.

### SUMMARY OF THE INVENTION

The present invention includes many aspects and features. Moreover, while many aspects and features relate to, and are described in, the context of musical instruction, the present invention is not limited to use only in musical instruction, as will become apparent from the following summaries and detailed descriptions of aspects, features, and one or more embodiments of the present invention. For example, systems and methods of the present invention may be utilized in instruction on musical or theatrical production, including lighting, as well as audio engineering and computer based recording, including mixing, in such various implementations.

Accordingly, a broad aspect of the present invention relates to a method of instruction by a teacher to a student with hands-on training. The method includes: presenting instruction to the student by the teacher; recording portions of the instruction presented; and storing the recording such that the recording is accessible via a wide area network by the student using an electronic device for viewing of the recorded portions of the lesson after the lesson has been taken.

A system for providing instruction by a teacher to a student includes a recording studio whereat a lesson is provided by the teacher to the student; recording equipment configured to record portions of the lesson; computer hardware and software configured to store recordings and provide access to the student, after the lesson has been taken, for selective playback and viewing by the student of recorded portions of the lesson.

In a feature of this aspect, the computer hardware and software is configured to provide access to the recordings over a wide area network, such as the Internet, for selective playback and viewing by the student.

In another feature, the instruction includes hands-on training by the student.

In another feature, the lesson is a music lesson.

In another feature, the lesson is an acting lesson.

In another feature, the lesson is a dance lesson.

In another feature, the audio and video of the lesson are recorded with a single recording device.

In another feature, multiple concurrent recordings are made of the lesson as it is taken. The multiple recordings may include video recordings and sound recordings.

In another feature, audio of the lesson is recorded for later playback to the student.

In another feature, video of the lesson is recorded for later playback to the student.

In another feature, audio of the student is recorded with a first device and video of the student is recorded with a second device. The video of the student may include or consist of a close-up of hands of the student playing a musical instrument.

In another feature, during the lesson, audio of the teacher is recorded with a first device, audio of the student is recorded with a second device, video of the teacher is recorded with a third device, and video of the student is recorded with a fourth device. The recordings preferably are simultaneously made during the lesson; the video of the teacher preferably includes or consists of a close-up of hands of the teacher playing a musical instrument, and the video of the student preferably includes or consists of a close-up of hands of the student playing a musical instrument. The audio of the teacher preferably includes audio of the musical instrument played by the teacher, and the audio of the student preferably includes audio of the musical instrument played by the student.

In another feature, the recording is made accessible for viewing by the student by streaming data representing the recording to an electronic device of the student whereby the recording is played to the student.

In another feature, the recording is made accessible for viewing by the student by enabling the student to download and save data representing the recording to an electronic device of the student whereby the recording is stored and selectively played thereafter on the electronic device of the student.

In another feature, the data from each recording device is chronologically synchronized such that a coordinated playback may be viewed of one or more of the recordings of the lesson. In this respect, the student preferably selectively views and listens to any combination of the recordings during playback of the lesson. Moreover, the playback preferably includes a display showing multiple video recordings taken concurrently during the lesson. The display may include a split screen display.

In another feature, text is added to the recording for later viewing during playback. The text may include scrolling advertisement.

In another feature, the teacher can monitor how many times the recordings are viewed by the student.

In another feature, the student can upload the recordings to a website.

In another aspect, a method of musical instruction by a teacher to a student with hands-on training includes the steps of: presenting instruction to the student by the teacher in the form of a lesson; recording portions of the lesson presented; and storing the recording such that the recording is accessible via the Internet by the student for viewing after the lesson is taken.

Audio and video of the lesson preferably are recorded. More particularly, the method preferably includes recording audio of the student with a first device and recording video of the student with a second device, and recording audio of the teacher with a third device and recording video of the teacher with a fourth device. Video of the student preferably includes or consists of a close-up of hands of the student playing a musical instrument; and video of the teacher preferably includes or consists of a close-up of hands of the student playing a musical instrument

In a feature of this aspect, the recording is made accessible for viewing by the student by streaming data representing the recording to an electronic device of the student whereby the recording is played to the student.

In another feature of this aspect, the recording is made accessible for viewing by the student by enabling the student to download and save data representing the recording to an electronic device of the student whereby the recording is stored and selectively played thereafter on the electronic device of the student.

In another feature of this aspect, the method further includes the step of chronologically synchronizing the data from each recording device whereby a coordinated playback may be viewed of one or more of the recordings of the lesson; and in a feature, the method further includes the step of enabling the student to selectively view and listen to any combination of the recordings during playback.

In an aspect of the invention, a method of musical instruction of a student, comprising the steps of: instructing the student by a teacher in the form of a one-on-one private music lesson with hands-on training with a musical instrument by the student; recording the instruction of the student by the teacher; storing the recording for viewing after the lesson is taken; and providing access to the recording, by the student over the Internet, whereby the student may view the recording.

In a feature, the step of recording the instruction of the student by the teacher comprises recording both audio and video of the teacher and the student.

In a feature, the step of recording the instruction of the student by the teacher comprises recording both audio and video of the teacher using recording equipment and recording audio and video of the student using different recording equipment.

In a feature, video of the teacher that is recorded includes a close-up of hands of the teacher playing another musical instrument, and wherein video that is recorded of the student includes a close-up of hands of the student playing the musical instrument at the same time as the teacher plays the other musical instrument.

In a feature, access to the recording is provided by streaming over the Internet data representing the recording to an electronic device of the student whereby the recording is played back to the student.

In a feature, access to the recording is provided by enabling the student to download and save data representing the recording to an electronic device of the student whereby the recording is stored for playback to the student on the electronic device of the student.

In a feature, the method further includes selecting, by the student, a portion of the recording for playback.

In a feature, the method further includes selecting, by the student, multiple chronologically synchronized portions of the recording for playback at the same time; and further may include viewing the selected multiple chronologically synchronized portions of the recording within split screens of a display.

In a feature, the method further includes adding text to the recording after the recording is complete for later viewing of the text during playback of at least a portion of the recording. The text may be an advertisement of goods or services.

In a feature, providing access to the recording comprises providing a hyperlink for playback of at least a portion of the recording, and further comprising posting the hyperlink on a page of the student at a social networking site.

In a feature, the method further includes uploading at least a portion of the recording to a social networking site.

In another aspect, a method of musical instruction of a plurality of students in one-on-one private music lessons includes the steps of: for each music lesson, (i) instructing each student by a teacher with hands-on training with a musical instrument by the student, and (ii) recording the instruction of the student by the teacher; storing the recording of each music lesson for viewing by the respective student receiving the lesson after the lesson is taken such that the recordings are accessible over the Internet; and providing access by each respective student to the recordings of those lessons taken by the respective student for later viewing of the recordings.

In another aspect, a system for providing music instruction by teachers to students at a musical instruction facility includes: a plurality of rooms located at the musical instruction facility in which lessons are provided by teachers to students; recording equipment comprising at least one recording device located in each of the rooms, the recording equipment in each respective room configured to record hands-on training by a student during at least a portion of a lesson that is provided by a teacher to the student in the respective room; and computer hardware and software configured to (i) store recordings of lessons that are taken using the recording equipment in each room, and (ii) provide, to a particular student, access over the Internet to a stored recording of a lesson provided to that particular student.

In a feature, the recording equipment in each room comprises a microphone and a video camera.

In a feature, the recording equipment in each room comprises a plurality of microphones and a plurality of video cameras, the recording equipment configured to record different fields of view of at least a portion of the lesson that is provided.

The different fields of view may comprise a first view of the teacher and a second view of the student; the different fields of view may comprise a first broad view of the student and a second close-up view of the student; or combination thereof.

In a feature, the computer hardware and software is configured to provide streaming over the Internet of audiovisual content of the recording for viewing.

In a feature, the computer hardware and software is configured to provide downloading over the Internet of audiovisual content of the recording.

In a feature, the computer hardware and software comprises a server located at the musical instruction facility at which the recordings are saved.

In a feature, the computer hardware and software comprises a cloud server by which access to the recording is provided to the particular student.

In a feature, the computer hardware and software comprises cloud data storage in which the recordings are saved.

In a feature, the computer software is configured to provide, with access to the stored recording, video content in the form of an advertisement.

In a feature, the computer software is configured to monitor how many times a stored recording is accessed.

In a feature, the computer software is configured to chronologically synchronize two or more recordings of the same lesson such that a coordinated playback may be viewed of the two or more recordings of the same lesson.

In another aspect, a method includes the steps of: effecting recording of a musical lesson of a student by an instructor, said recording including, (i) recording, using separate video cameras, the playing of a first musical instrument by the student and the playing of a second musical instrument by the instructor, and recording, using one or more microphones, the playing of one or more musical instruments by the student, the instructor, or the student and the instructor; and effecting provision of electronic access, to a user, to the recordings of the musical lesson. The recordings are configured to allow one or more of the recordings of the musical lesson to be synchronized, and the provision of electronic access includes allowing a user to select two or more recordings of the musical lesson for synchronized, simultaneous playback.

In other aspects, the foregoing systems and methods are utilized to provide instruction in theater productions; sound recordings and mixing; and lighting.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein:

FIG. 1 illustrates a preferred method and system for providing musical instruction in accordance with one or more aspects of the present invention;

FIG. 2 also illustrates another preferred method and system for providing musical instruction in accordance with one or more aspects of the present invention;

FIG. 3 illustrates different fields of view of video camera recordings that may be taken during a guitar lesson in accordance with one or more aspects of the present invention;

FIG. 4 illustrates different fields of view of video camera recordings that may be taken during a piano lesson in accordance with one or more aspects of the present invention;

FIG. 5 illustrates a musical instruction facility—such as a music academy—wherein musical instruction is provided using one or more preferred embodiments in accordance with one or more aspects of the present invention;

FIG. 6 illustrates a first architecture for storing and accessing one or more recorded lessons taken for each of a plurality of students in accordance with one or more aspects of the present invention;

FIG. 7 illustrates a second architecture for storing and accessing one or more recorded lessons taken for each of a plurality of students in accordance with one or more aspects of the present invention;

FIG. 8A illustrates audio and video recording devices installed and configured for use in accordance with a commercial embodiment of the present invention;

FIG. 8B also illustrates audio and video recording devices installed and configured for use in accordance with a commercial embodiment of the present invention

FIG. 9A illustrates a graphical user interface in accordance with a commercial embodiment of the present invention;

FIG. 9B illustrates a graphical user interface in accordance with a commercial embodiment of the present invention;

FIG. 10A illustrates a graphical user interface in accordance with a commercial embodiment of the present invention;

FIG. 10B illustrates a graphical user interface in accordance with a commercial embodiment of the present invention;

FIG. 11A illustrates a graphical user interface in accordance with a commercial embodiment of the present invention;

FIG. 11B illustrates a graphical user interface in accordance with a commercial embodiment of the present invention;

FIG. 12A illustrates a graphical user interface in accordance with a commercial embodiment of the present invention;

FIG. 12B illustrates a graphical user interface in accordance with a commercial embodiment of the present invention;

FIG. 13A illustrates a graphical user interface in accordance with a commercial embodiment of the present invention;

FIG. 13B illustrates a graphical user interface in accordance with a commercial embodiment of the present invention;

FIG. 14A illustrates a graphical user interface in accordance with a commercial embodiment of the present invention;

FIG. 14B illustrates a graphical user interface in accordance with a commercial embodiment of the present invention;

FIG. 15A illustrates a web page in accordance with a commercial embodiment of the present invention;

FIG. 15B illustrates the web page of FIG. 15A after the username and password of a student have been entered and the login button clicked;

FIG. 16 illustrates the web page following successful submission of the username and password in the web page of FIG. 15B, in which resulting web page information regarding one or more lessons of the student are displayed, including a hyperlink for each lesson;

FIG. 17 illustrates the web page following clicking on a particular lesson shown in the web page of FIG. 16, which web page includes a video player in an initially paused state; and

FIG. 18 illustrates the playback of audiovisual context that occurs upon clicking the video player of the web page shown in FIG. 17.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

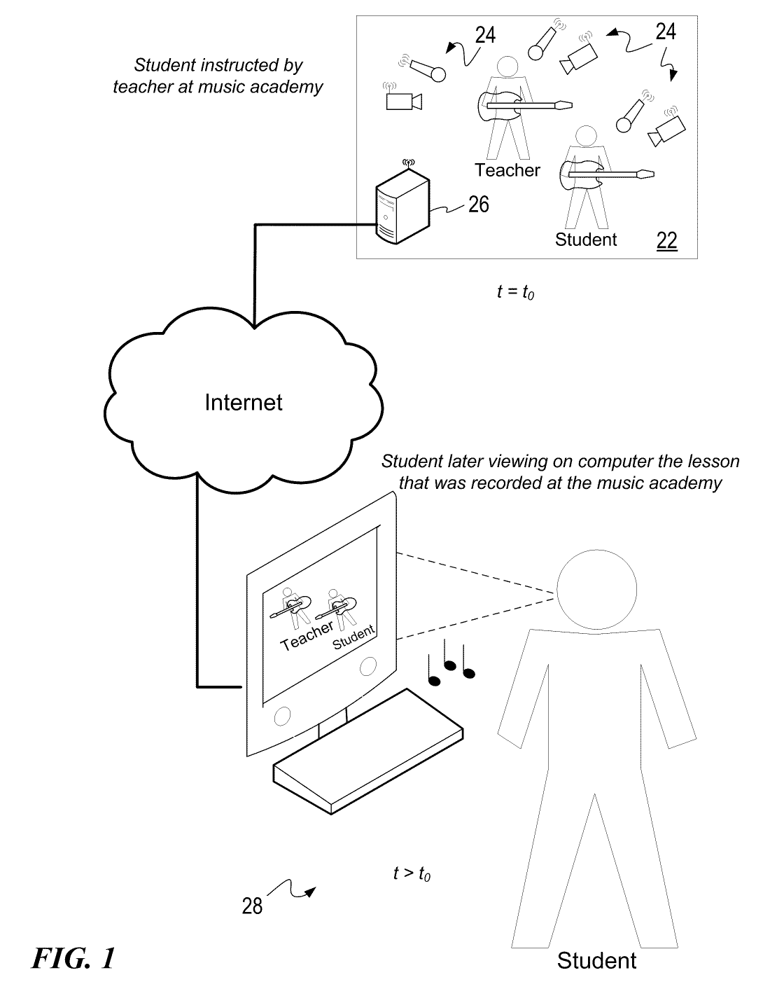

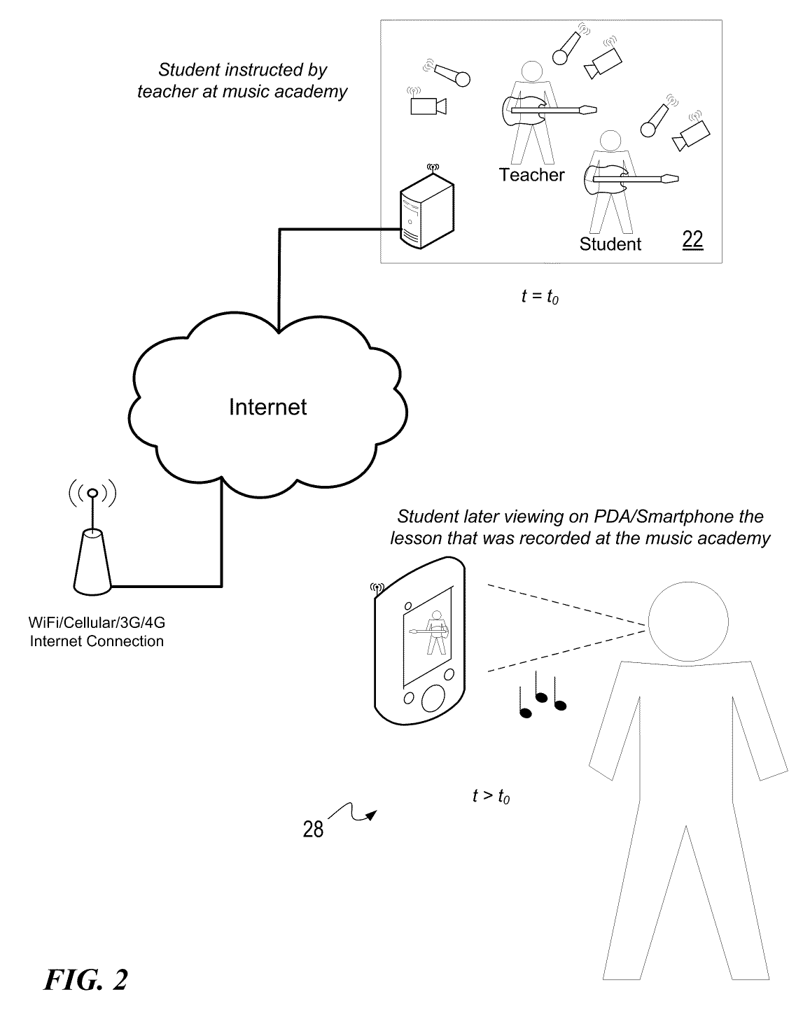

Each of FIGS. 1 and 2 illustrates a preferred method and system for providing musical instruction in accordance with one or more aspects of the present invention. However, it will be appreciated that the present invention, including the methods and systems described herein, is not limited to providing musical instruction, but is broad enough to cover other types of instruction.

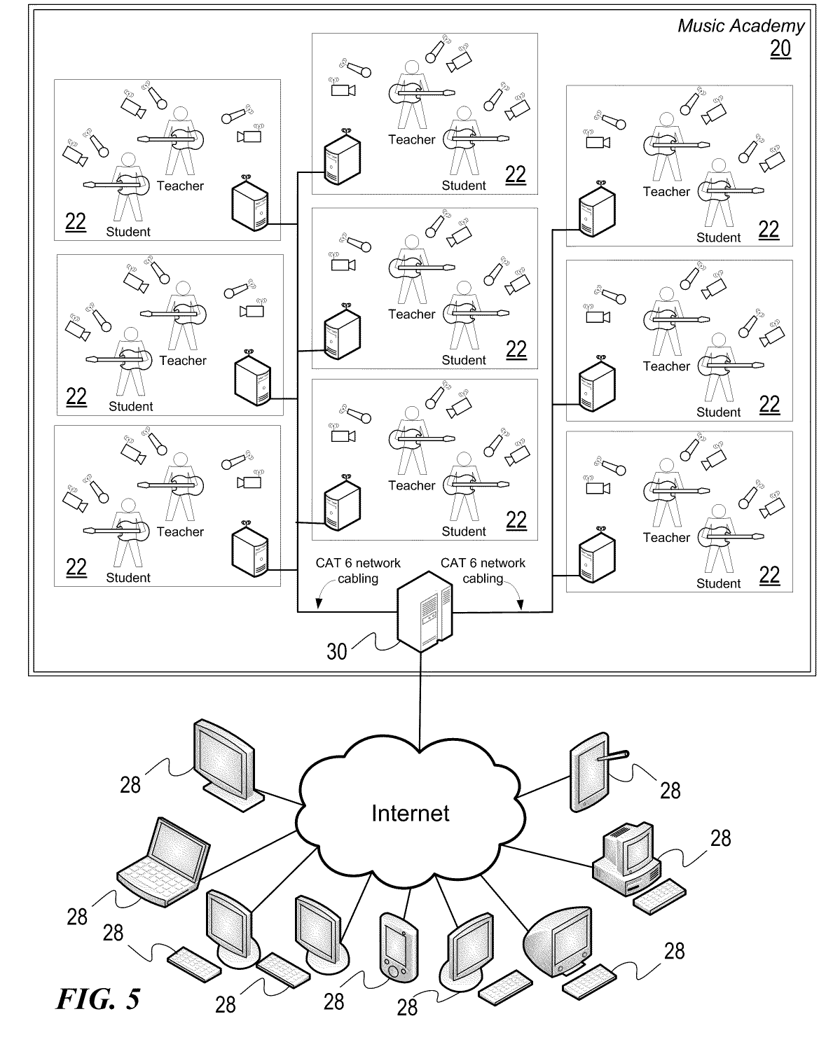

In accordance with the preferred method and system of FIG. 1, a student is provided musical instruction by a professional music teacher in a classroom or recording studio 22 at a musical instruction facility such as, for example, the music academy represented generally by reference 20 in FIG. 5. Preferably, the instruction is provided as a music lesson and represents a commercial service provided by the music academy. However, it is contemplated that the instruction may be provided covering any and all activities where professional instruction is useful, such as art, acting, or public speaking, and in any and all facilities appropriately equipped. The exemplary lesson being taken by the student in FIG. 1 is an electric guitar lesson.

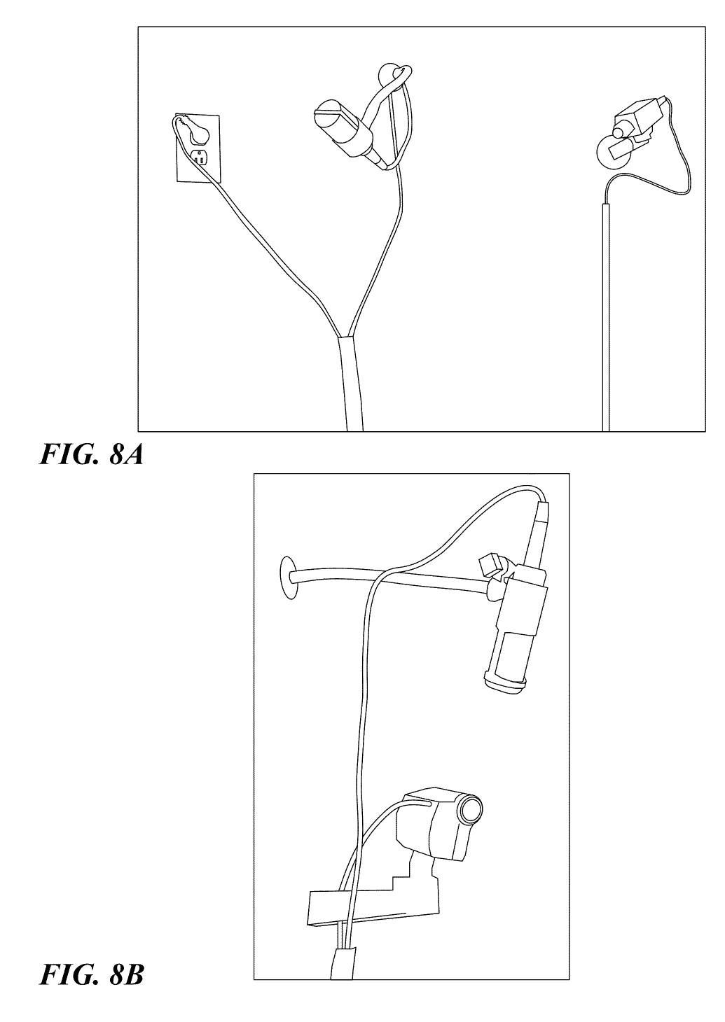

The room or studio in which the lesson is taken by the student includes one or more pieces of recording equipment, generally indicated by reference 24 in FIG. 1. Examples of recording equipment include microphones, electric guitar pickups, electronic keyboards, computers, and video cameras. In at least one preferred embodiment a condenser microphone is used. FIGS. 8A and 8B illustrate audio and video recording devices installed and configured for use with the above-disclosed system and method. Specifically, FIGS. 8A and 8B show microphones for capturing audio and video cameras for capturing video. Moreover, while these are shown as separate components, other equipment could similarly be used in which the microphone and camera are combined in a single piece of recording equipment.

The recording equipment as illustrated in FIG. 1 includes a plurality of video cameras and microphones, with the student being the primary subject of a first video camera and a first microphone, with the teacher being the primary subject of a second video camera and a second microphone, and with both the student and teacher being the primary subject of a third video camera and a third microphone. In addition or alternatively, the student's hands and interaction thereof with the student's guitar are the primary focus of a video camera (e.g., a camera is configured to zoom in on the student's playing of the guitar); the instrument played by the student is the primary focus of a microphone (e.g., the student's guitar is miked); the teacher's hands and interaction thereof with the teacher's guitar are the primary focus of a video camera (e.g., a camera is configured to zoom in on the teacher's playing of the guitar); the instrument played by the teacher is the primary focus of a microphone (e.g., the teacher's guitar is miked); the teacher's verbal instructions given are the primary focus of a microphone (e.g., the teacher is miked); and the comments and questions asked by a student are the primary focus of a microphone (e.g., the student is miked). Each microphone and camera may be wireless, as represented in FIG. 1, or alternatively, one or more of them may be wired.

A controller for managing collection of the video and sound data captured by the cameras and microphones also is represented at the musical instruction facility by computer 26. The computer 26 preferably processes the data that is wirelessly transmitted by each camera and microphone, such processing including chronologically synchronizing the images and sounds that are captured. In this process, the data from each of the cameras and microphones preferably is associated with a time index for later synchronized playback of any desired combination of the recordings.

The computer 26 is illustrated in FIG. 1 as being arranged, either directly or indirectly, in electronic communication with a wide area network (WAN) such as, preferably, the Internet. (Indeed, in FIG. 5, the computer 26 is shown indirectly connected to the Internet by way of a gateway server, described below.) The student also is illustrated generally by reference 28 at a later point in time t₁, after the illustrated lesson has been taken at time t₀, using a desktop computer that is also arranged, either directly or indirectly, in electronic communication with the Internet.

In accordance with the preferred method and system of FIG. 1, the student is able to access and view—preferably at any time after the lesson, and on demand—at least one and preferably any combination of the recordings that were made during the lesson that was taken. This is illustrated in FIG. 1 by the student viewing both audio and visual playback on the computer monitor of the recording of the teacher and student playing the guitars during the lesson that was taken. Other electronic devices further may be used for viewing playback of recordings in accordance with preferred embodiments of the present invention, too. For example, a personal digital assistant or smartphone (such as an iPhone or Blackberry) that is wireless and Internet-enabled may be used, as represented in FIG. 2.

The playback to the student may comprise streaming the data to the student, wherein the playback is transient and is shown but not permanently saved by the student on the student's device. Such streaming can be initiated by clicking a hyperlink within a web browser. The linked audiovisual content to be displayed is streamed to the browser, and most likely, a plug-in of the browser for playing of the linked audiovisual content. The data of the audiovisual content is stored so as to be accessible via the Internet. The hyperlink preferably is accessible to the student via a website of the music academy. In alternative implementations, however, the hyperlink may be emailed or otherwise provided to the student.

Moreover, the student then may provide the hyperlink to others for playback, such as to friends and family of the student. This may be accomplished by the student sending the hyperlink via email. Alternatively, this may be accomplished by posting the hyperlink to a page of the student at a social networking site, such as Twitter or Facebook, whereby friends and followers of the student may readily click on the hyperlink and view the student's audiovisual content themselves. It is believed that grandparents and other family members would be very interested in viewing lessons taken by the student, especially where such family members live apart from the student and are not involved with the student on a daily basis.

Alternatively, rather than streaming the data, the data of the playback may be downloaded to the student's device and saved by the student for later playback and archiving by the student independent of an Internet connection after downloading. Examples of digital storage media on which such data may be saved by the student include CDs, DVDs, digital audiovisual players, computer hard drives, USB flash drives, or any other digital data storage device. Moreover, it is contemplated that the student may further selectively upload the data to YouTube, Facebook, or other websites, especially social networking sites, for playback and viewing, such as by family and friends of the student.

In accordance with at least some embodiments of the invention, it is contemplated that text or images may be added to the data of the audiovisual content so that, during playback, such additional information is presented for viewing. Examples of such additional information include information that may be saved and maintained by the instructor regarding the lesson (discussed below), and commercial advertisements, such as, for example, for sales of musical instruments and musical instruction services provided by the music academy.

The ability to access the recordings by the student after having taken the lesson, on demand on his or her home computer or other electronic device, is believed to materially add to the value and benefit of the lesson and extend the instructional and educational benefit of the lesson to the student. Indeed, it is believed to be very advantageous to allow the student to review and study the content of the lesson repeatedly at home or elsewhere.

It will be appreciated that a video camera and microphone may be separate components, or may be components of a single device. The use of multiple cameras and microphones is preferred for purposes of capturing the visual content of the lesson from different angles or perspectives and independently capturing the different sounds that are made for later individual playback and focus.

It will be appreciated that the guitar lesson taken includes hands-on training of the student by the professional teacher. In the context of musical instruction, a lesson may include instruction on traditional band and orchestral instruments, as well as instruction for guitar, bass, vocals, piano, drums, mandolin, and banjo. It will further be appreciated that any audio or visual data, such as that representing verbal instruction, visual instruction, musical performance by the instructor, musical performance by the student, visual depictions of musical notation, acting performance by the instructor or the student, dance performance by the instructor or the student, oration by the instructor or the student, body positioning or posture, breathing techniques, etc., may be subject to recordings during the lesson for later playback after the lesson.

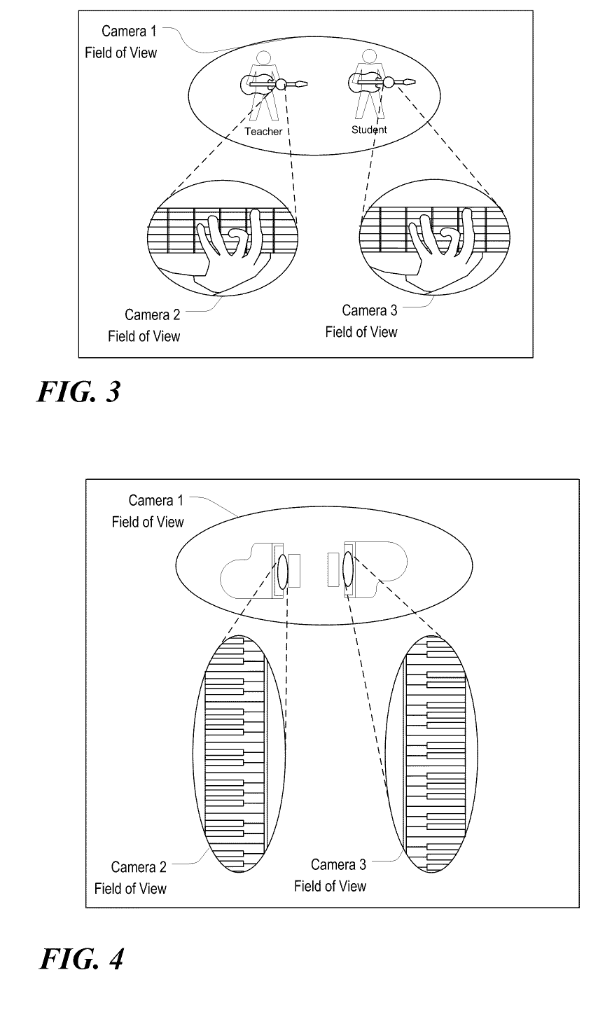

FIGS. 3 and 4 each illustrates different fields of view of cameras for making visual recordings during lessons in accordance with one or more aspects of the present invention. Specifically, FIGS. 3 and 4 illustrate multiple cameras being used to capture portions of a guitar lesson and a piano lesson, respectively. During playback, it is contemplated that one or more of the different fields of view may be selected for display, including the use of split screens for such display.

As shown in FIG. 3, a first video camera records a wide-angle shot of both the student and teaching professional during a guitar lesson. Meanwhile, second and third video cameras record close-up shots of the teacher's hands and student's hands, respectively, as the guitars are played. Simultaneously, multiple audio tracks are recorded (not shown), including a track with verbal instruction, as well as separate guitar tracks for the teacher and student. All of these tracks are synchronized and can be played back by the student at a later time. Ultimately, the student has the option to view the content of the lesson as captured by any one or more of the recording devices. Similarly, FIG. 4 shows a recording setup in the context of a piano lesson, wherein a first camera captures a wide-angle shot of both the student and teaching professional during the lesson, and wherein second and third cameras record close-up shots of the teacher's hands and student's hands, respectively, as the pianos are played. FIGS. 3 and 4 further represent possible display arrangements for viewing the three different visual recordings during playback of the respective lessons taken.

FIG. 5 illustrates an exemplary music academy 20 where music lessons may be taken concurrently by a plurality of students, each lesson being taken concurrently in a separate recording studio 22 of the music academy 20. Each recording studio is generally represented by the recording studio represented in FIGS. 1 and 2, and includes recording equipment for recording audio and visual portions of the lesson that is taken for later playback and viewing by a student as described above. The music academy further preferably includes a gateway server 30 that is connected in electronic communication with the Internet through which the data acquired during each lesson is communicated from the music academy.

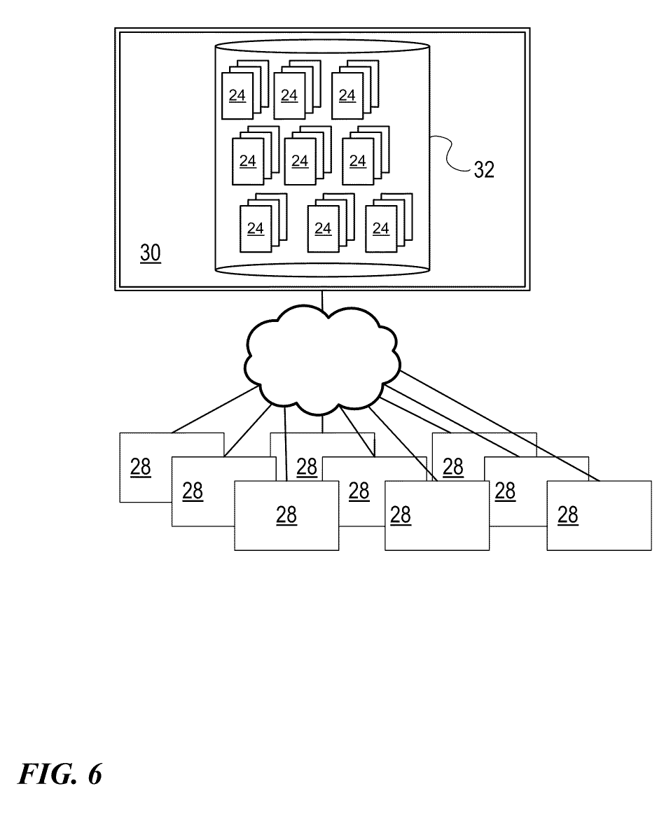

The recording from each lesson may be stored after processing on computer 26, which computer preferably processes the data acquired during the lesson from the cameras and microphones. Preferably, however, the data is stored for later access and playback at a central repository with data from other lessons. Such a central repository may include the gateway server 30 that is located onsite at the music academy and that provides Internet communications to and from the music academy. This scenario is graphically represented in FIG. 6. The central repository is shown as a logical volume 32 of gateway server 30, wherein each lesson's recordings are graphically represented by file collection 24. In this scenario the gateway server may also serve the aforedescribed function of the computer 26, provided the gateway server has sufficient processing capabilities for serving the number of studios and potential concurrent lessons being provided at a given time.

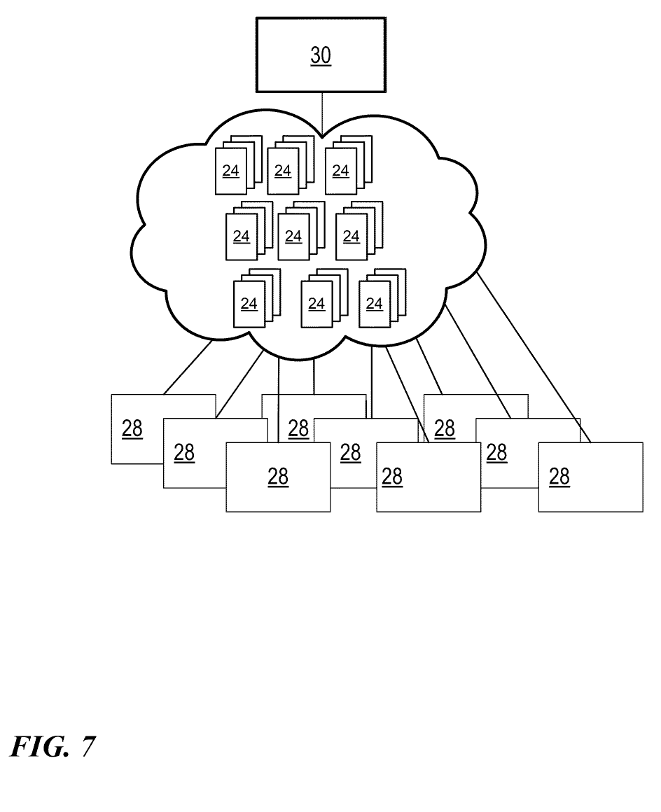

Alternatively, the central repository may be an online archive that is maintained “in the cloud” on third party servers, virtual clusters or logical drives, as graphically represented in FIG. 7. Such third party services are well known, and an exemplary service is currently provided by Rackspace US, Inc. at www.rackspacecloud.com under the “Cloud Servers”, “Cloud Sites”, and “Cloud Files” service offerings.

Of course, software that implements one or more embodiments of the present invention is required for handling access and playback of the recordings, which software is believed to be within the level of skill of the Ordinary Artisan to create when done in view of the disclosure of the present invention set forth herein.

In this scenario, the gateway server 30 may primarily provide and manage internet communications to and from the music academy. Alternatively, the gateway server may further execute the software implementing the present invention using, coordinating, and managing the content stored in the cloud.

Audio and video data compression techniques also may be used in storing the data in the file collections 24. Such techniques include MP3, MPEG-2, MPEG-4, Advanced Audio Coding, Ogg Vorbis, and FLAC. Such compression may be applied by the gateway server prior to uploading of the data to the cloud, or may be performed by the respective computer 26 that coordinates the recording of the data.

Additionally, under any of the foregoing scenarios, it is contemplated that each student will have access to only that student's music lesson content. A variety of techniques may be employed to limit access to only authorized users and ensure the security of the data, including password protecting access and encrypting the stored data. Moreover, communications over the Internet preferably are secured through encryption to avoid unauthorized interception and viewing of the playback by others.

Furthermore, credentials for such access, at least on a restricted or limited basis, may be included in hyperlinks that may be provided by the student to others under one or more of the aforedescribed scenarios. In this regard, family members and others who are provided such hyperlinks preferably have access only to viewing playback of a lesson without further access, such as to non-linked lessons or other information regarding the student.

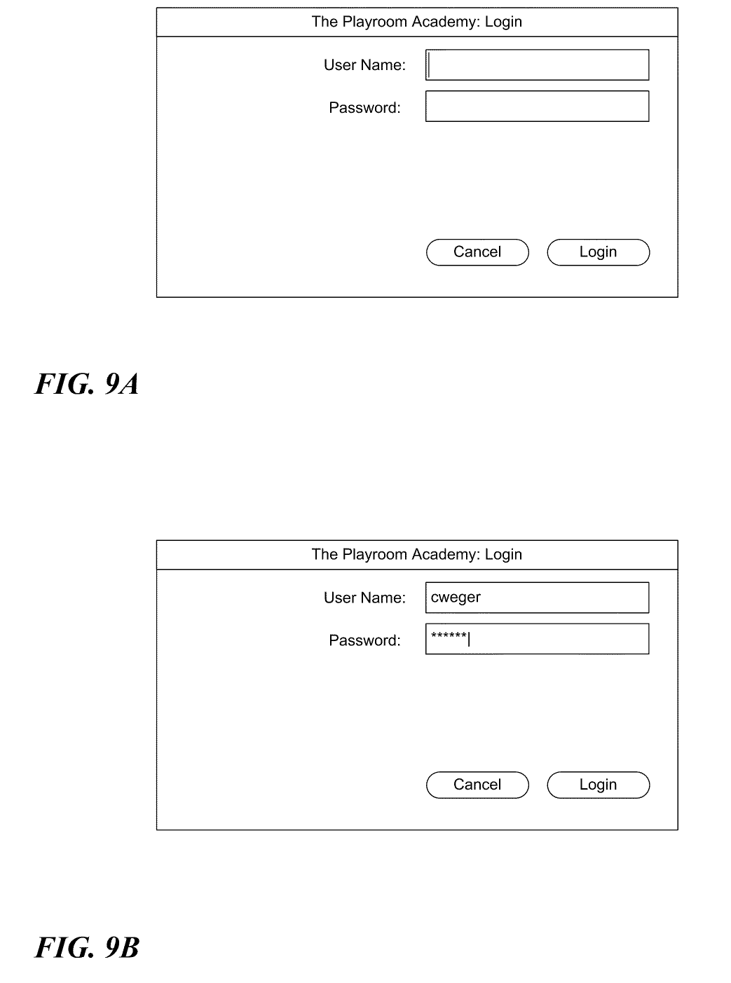

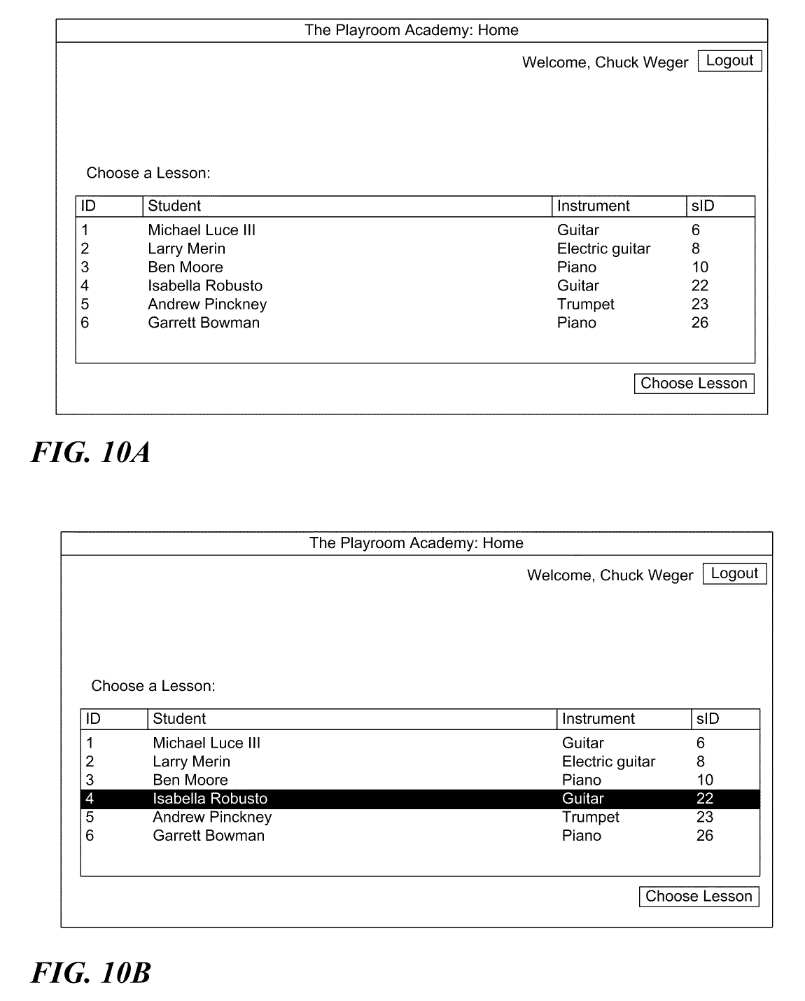

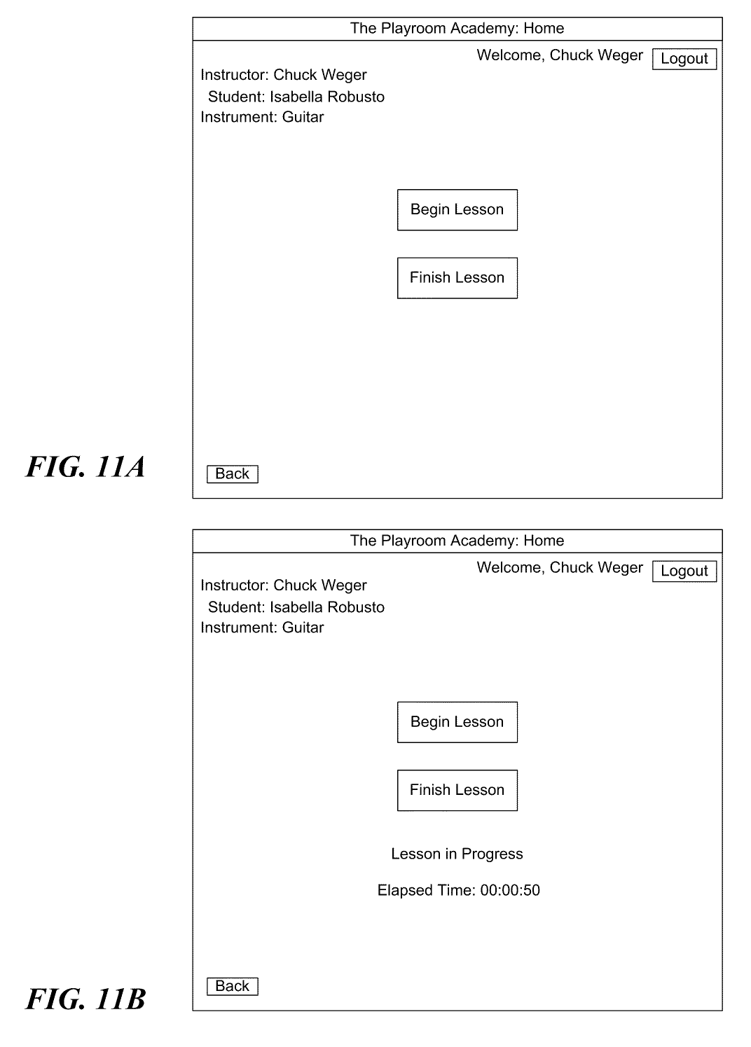

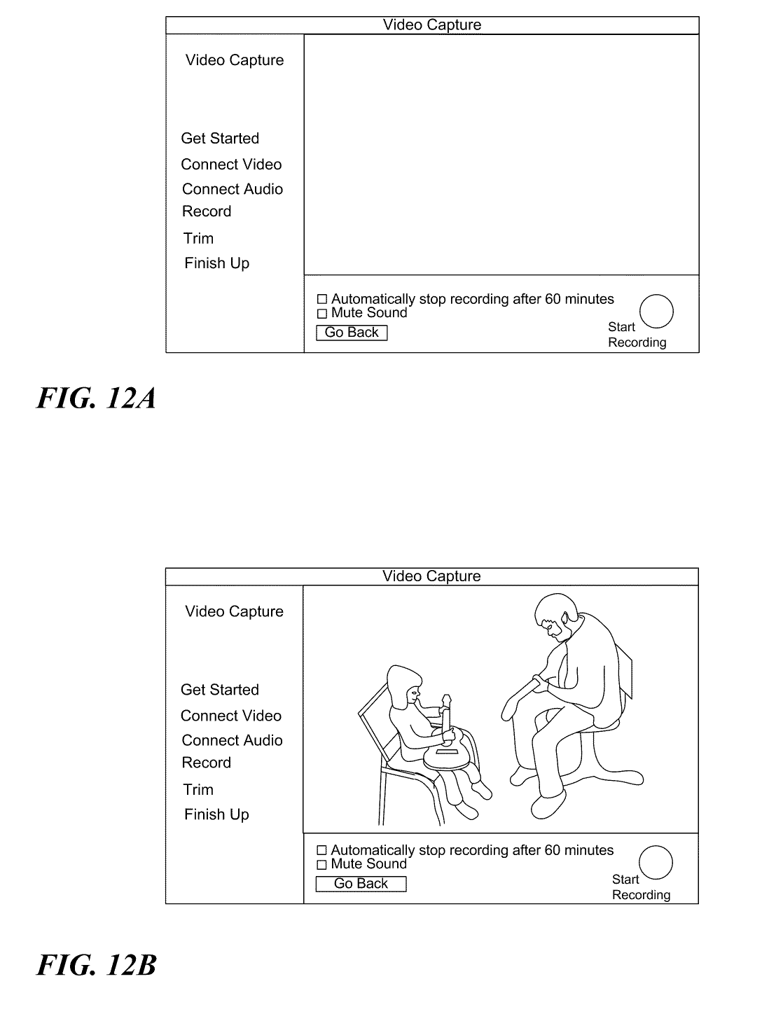

FIGS. 9A-14B are screenshots of graphical user interfaces of a preferred computer program used in conjunction with a commercial embodiment of the present invention. In accordance with the commercial embodiment, prior to starting a music lesson, a music instructor accesses a computer located within a lesson room. The instructor is presented with a login screen as shown in FIG. 9A. Once the instructor inputs a unique username and password, as shown in FIG. 9B, and clicks the “login” button, he or she is directed to the “Playroom Academy” home screen, as shown in FIG. 10A. The Home Screen presents the instructor with information regarding the scheduled lessons for the day. The instructor selects the student whose lesson is about to commence, as shown in FIG. 10B, and clicks the “Choose Lesson” button, at which point the computer displays the lesson screen, shown in FIG. 11A. Once the student is situated and the lesson is ready to begin, the instructor selects the “Begin Lesson” button, as shown in FIG. 11B, which activates a lesson clock and updates the lesson data. The lesson clock may be displayed during the lesson so that both instructor and student will readily know how far the lesson has progressed and how much time remains while the instruction is being provided. Furthermore, the video capture screen, shown in FIG. 12A, appears on the computer screen. To enable the recording devices, the instructor selects the “Start Recording” button on the video capture screen. As seen in FIG. 12B, the video capture screen and lesson screens are simultaneously displayed on the computer display.

After the music lesson is complete, the instructor selects the circular “Stop Recording” button on the video capture screen to deactivate the recording devices and then selects the “Go Back” button to close the video capture screen and return to the lesson screen of FIG. 11B. Once on the lesson screen, the instructor selects “Finish Lesson” to stop the lesson clock, whereupon a database is updated, and the instructor continues to the next screen.

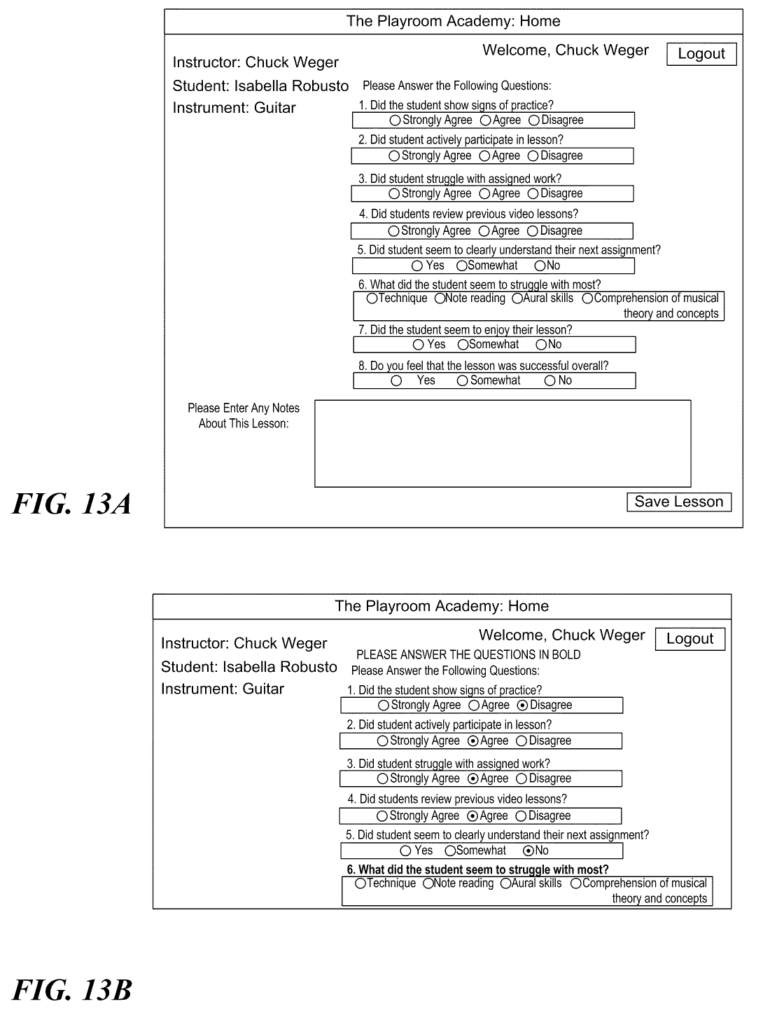

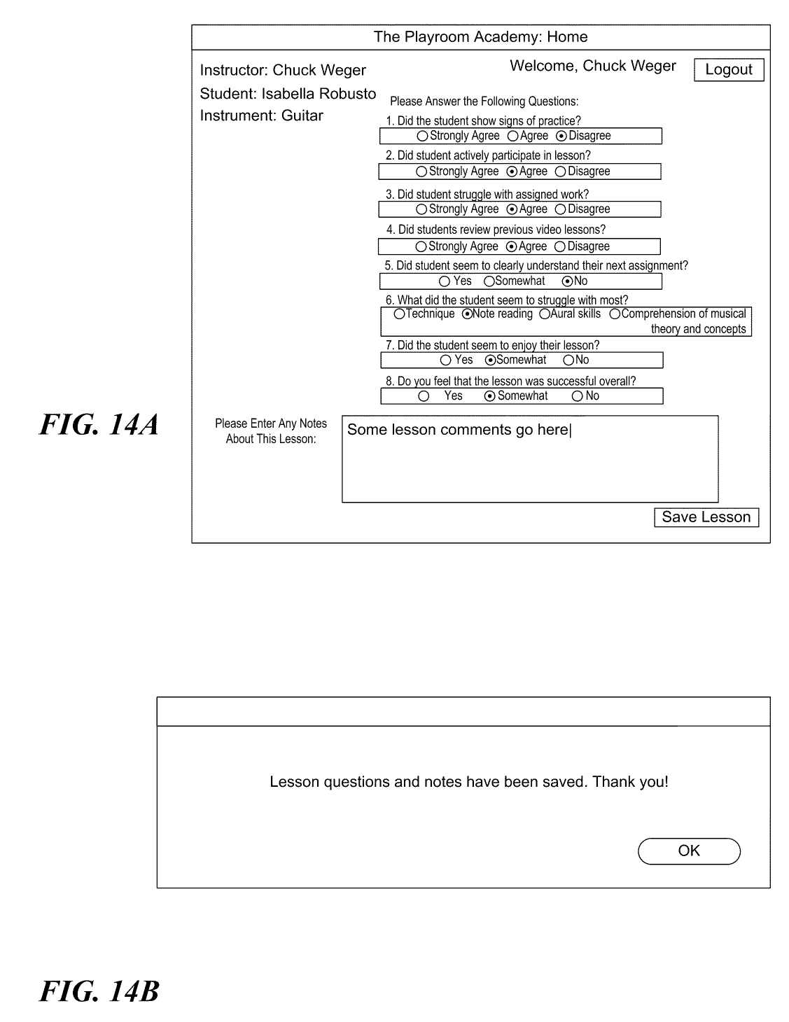

The next screen, as shown in FIGS. 13A-14A, is the lesson follow-up, or “Questionnaire”, screen. The lesson follow-up screen presents the instructor with a series of questions regarding the lesson and the student's performance, such as whether the student showed signs of practice, the student's participation, understanding, and enjoyment of the lesson, and overall success of the lesson. The screen may also have a space for the instructor to type notes. If the instructor attempts to click through this screen without completing the questionnaire in its entirety, an error message appears at the top of the page, as shown in FIG. 13B. Once the questionnaire is complete, as shown in FIG. 14A, the instructor may select the “save lesson” button, at which time a confirmation screen, as shown in FIG. 14B, appears. Once the instructor clicks “OK,” the computer will begin the process of packaging the audio/video data for communication and storage, whether such storage is onsite or offsite. The data contained in the questionnaire may be used to track a student's musical progress over time and assist an instructor in providing feedback to the student or the student's parents.

Furthermore, in at least one preferred embodiment, an instructor may access a master lesson list displaying data associated with each recording and/or lesson. The data associated with each recording and/or lesson may include the date and time the recording was made, the student, the instructor, the type of lesson (i.e. piano, drums, voice, acting, etc.), the number of times the recording has been viewed, the date and time of the most recent viewing, a hyperlink to an associated questionnaire, and the electronic location of the recording file. The master lesson list provides a valuable quality control tool for the instructors.

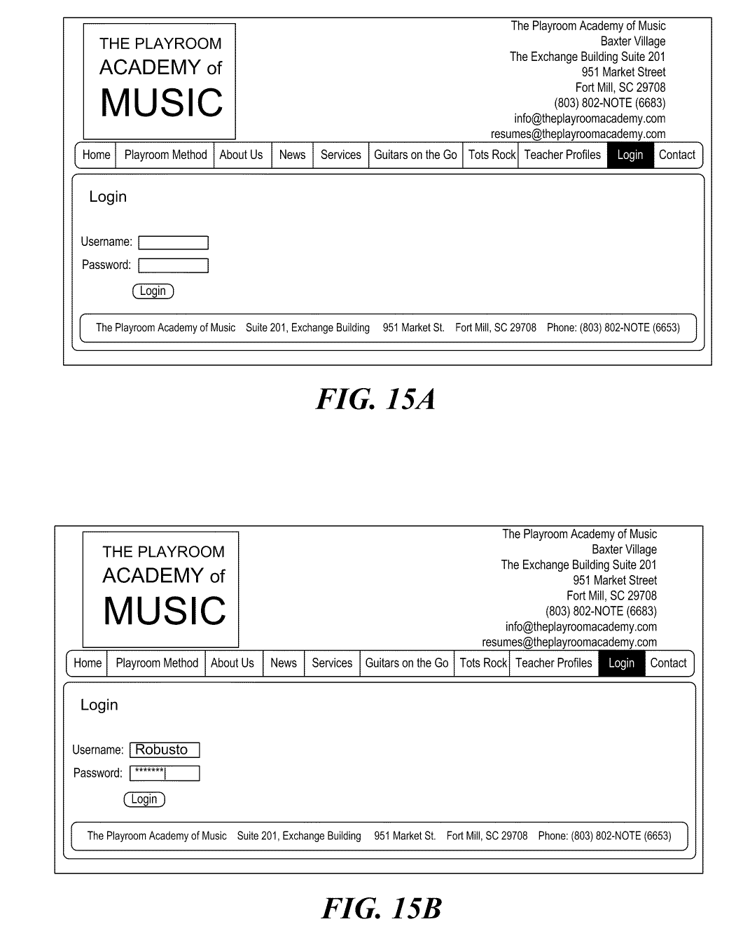

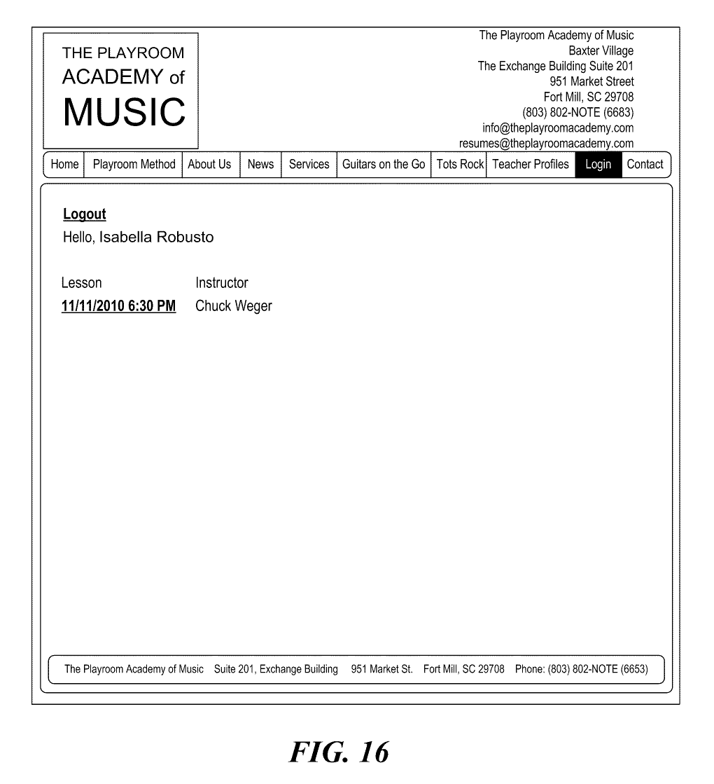

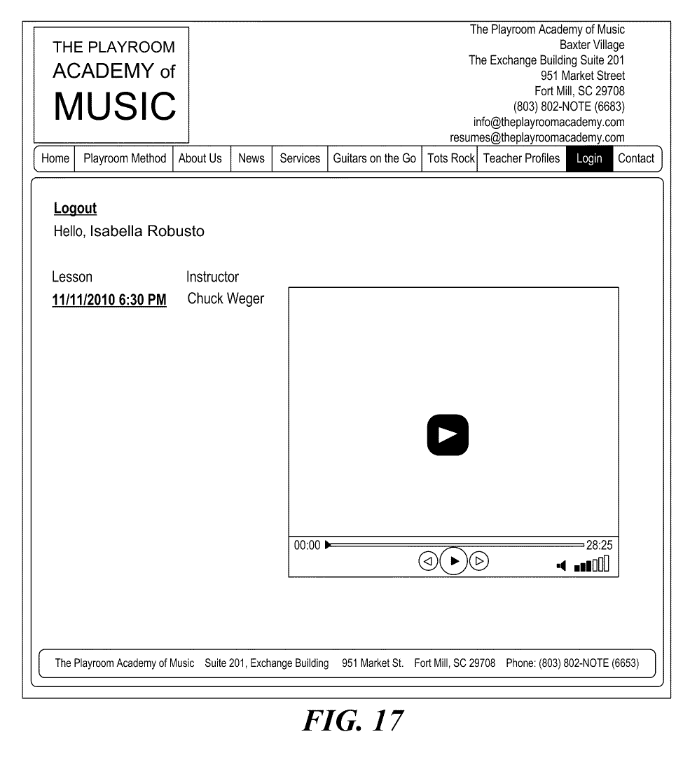

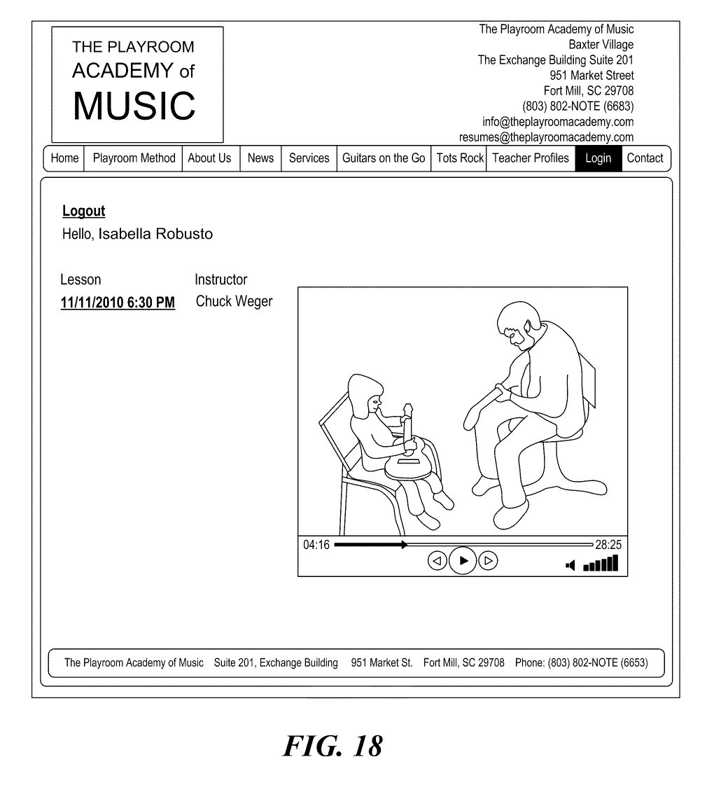

With regard to FIGS. 15A through 18, web pages associated with the user experience by a student accessing a recording for a lesson that the student has taken are illustrated in accordance with a commercial embodiment of the present invention. In particular, FIG. 15A illustrates a web page by which a student accesses recordings of lessons that the student has taken. FIG. 15B illustrates a web page after the username and password of a particular student have been entered. Upon clicking the “login” button, the student is taken to the web page of FIG. 16. As shown in FIG. 16, information regarding one or more lessons that the student has taken is displayed. For this particular student, only one lesson has been taken. The lesson information that is shown includes the date, time and instructor of the lesson. Furthermore, the date and time of the lesson are displayed as a hyperlink. Clicking on this hyperlink causes the web page of FIG. 17 to be displayed. The web page of FIG. 17 includes a video player by which the recording of the lesson can be viewed. Clicking on the video player results in the playback of the lesson for viewing, as illustrated in FIG. 18. By viewing the lesson by the student, greater retention of the instruction at the lesson is believed to be provided leading to improved learning by the student.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Indeed, while preferred embodiments have been described in the context of music lessons, a lesson provided in accordance with the present invention may be provided in the context, for example, of lighting, audio engineering, and computer based recordings.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A method of musical instruction of a student, comprising the steps of:
(a) instructing the student by a teacher in the form of a one-on-one private music lesson with hands-on training with a musical instrument by the student;
(b) recording the instruction of the student by the teacher;
(c) storing the recording for viewing after the lesson is taken; and
(d) providing access to the recording, by the student over the Internet, whereby the student may view the recording.

2. The method of claim 1 wherein the step of recording the instruction of the student by the teacher comprises recording both audio and video of the teacher and the student.

3. The method of claim 1, wherein the step of recording the instruction of the student by the teacher comprises recording both audio and video of the teacher using recording equipment and recording audio and video of the student using different recording equipment.

4. The method of claim 3 wherein video of the teacher that is recorded includes a close-up of hands of the teacher playing another musical instrument, and wherein video that is recorded of the student includes a close-up of hands of the student playing the musical instrument at the same time as the teacher plays the other musical instrument.

5. The method of claim 1, wherein access to the recording is provided by streaming over the Internet data representing the recording to an electronic device of the student whereby the recording is played back to the student.

6. The method of claim 1, wherein access to the recording is provided by enabling the student to download and save data representing the recording to an electronic device of the student whereby the recording is stored for playback to the student on the electronic device of the student.

7. The method of claim 1, further comprising selecting, by the student, a portion of the recording for playback.

8. The method of claim 1, further comprising selecting, by the student, multiple chronologically synchronized portions of the recording for playback at the same time.

9. The method of claim 8, further comprising viewing the selected multiple chronologically synchronized portions of the recording within split screens of a display.

10. The method of claim 1, further comprising adding text to the recording after the recording is complete for later viewing of the text during playback of at least a portion of the recording.

11. The method of claim 1, wherein providing access to the recording comprises providing a hyperlink for playback of at least a portion of the recording, and further comprising posting the hyperlink on a page of the student at a social networking site.

12. The method of claim 1, further comprising uploading at least a portion of the recording to a social networking site.

13. A method of musical instruction of a plurality of students in one-on-one private music lessons, comprising the steps of:
(a) for each music lesson,
(i) instructing each student by a teacher with hands-on training with a musical instrument by the student, and
(ii) recording the instruction of the student by the teacher;
(b) storing the recording of each music lesson for viewing by the respective student receiving the lesson after the lesson is taken such that the recordings are accessible over the Internet; and
(c) providing access by each respective student to the recordings of those lessons taken by the respective student for later viewing of the recordings.

14. A system for providing music instruction by teachers to students at a musical instruction facility, comprising:
(a) a plurality of rooms located at the musical instruction facility in which lessons are provided by teachers to students;
(b) recording equipment comprising at least one recording device located in each of the rooms, the recording equipment in each respective room configured to record hands-on training by a student during at least a portion of a lesson that is provided by a teacher to the student in the respective room; and
(c) computer hardware and software configured to,
(i) store recordings of lessons that are taken using the recording equipment in each room, and
(ii) provide, to a particular student, access over the Internet to a stored recording of a lesson provided to that particular student.

15. The system of claim 14, wherein the recording equipment in each room comprises a microphone and a video camera.

16. The system of claim 14, wherein the recording equipment in each room comprises a plurality of microphones and a plurality of video cameras, the recording equipment configured to record different fields of view of at least a portion of the lesson that is provided.

17. The system of claim 14, wherein the computer hardware and software is configured to provide streaming over the Internet of audiovisual content of the recording for viewing.

18. The system of claim 14, wherein the computer hardware and software is configured to provide downloading over the Internet of audiovisual content of the recording.

19. The system of claim 14, wherein the computer software is configured to monitor how many times a stored recording is accessed.

20. The system of claim 14, wherein the computer software is configured to chronologically synchronize two or more recordings of the same lesson such that a coordinated playback may be viewed of the two or more recordings of the same lesson.
